(19) United States
(12) Patent Application Publication
(10) Pub. No.: US 2009/0284391 A1
(43) Pub. Date: Nov. 19, 2009

(54) Apparatus for mounting a telematics user interface

(76) Inventors: Eric Berkobin, Woodstock, GA (US); Charles M. Link, II, Atlanta, GA (US)

Correspondence Address: HUGHES TELEMATICS, INC., 41 PERIMETER CENTER EAST, SUITE 400, ATLANTA, GA, 30346, US

(21) Appl. No.: 12/466,040

(22) Filed: May 14, 2009

Related U.S. Application Data
(60) Provisional application No. 61/053,456, filed on May 15, 2008.

(51) Int. Cl. G08C 19/16; A47B 96/06

(52) U.S. Cl. 340/870.01; 248/226.11; 248/205.1

(57) ABSTRACT

A user interface to an electronic unit, such as a telematics unit, couples with the unit. The interface can also provide access to audio, computer, communications, navigation, and other units besides telematics device units. A user can secure the interface to a rear view mirror of a vehicle using clips; a securing means that exerts force against the interface and a roof, or other surface, of the vehicle that the user wishes to fix the interface in; or other methods of attaching devices to one another. A housing of the interface may locate the biasing means so that the biasing means forces the housing against the rearview mirror. The interface may couple to a telematics, or other electronics, unit located, or installed, in the vehicle via a cable link, including wire and optical, or via a wireless link.

### CROSS REFERENCE TO RELATED APPLICATION

This application claims priority under 35 U.S.C. 119(e) to U.S. provisional patent application No. 61/053,456 entitled “Telematics user interface,” which was filed May 15, 2008, and which is incorporated herein by reference in its entirety.

### SUMMARY

Provided is a telematics user interface that can be mounted in a vehicle.

A user interface that facilitates interaction between a user and an electronics device includes a power source, one or more user inputs, a microphone and a speaker, and a user interface port coupled to the power source, the one or more user inputs, and the microphone and speaker. A manufacturer, installer, or user may configure the interface port for coupling the apparatus to vehicle electronics unit. One or more of the user inputs may comprise one or more of, push buttons and touch sensitive areas. One of the user inputs may comprise an emergency button, or a non-emergency button. The one or more user inputs may, or may not be, illuminated. The power source may comprise a user replaceable battery, or a pin for receiving electrical power from a cable external to the user interface.

The user interface may also include a separate housing that defines a bottom surface having outer ends formed lower than a center of the bottom surface. A manufacturer forms the bottom surface of the housing to mate with the top of a rearview mirror used in a vehicle, such as, for example, an automobile, a truck, a bus, a boat, an airplane, or a train. The housing also defines a top. A means for securing the apparatus with respect to the rear view mirror exerts force against the roof, or other surface above the rearview mirror.

The means for locating the apparatus may include a plunger assembly that has a plunger defining a flange and a distal end. A spring exerts force against the top of the apparatus, or apparatus housing, and against the flange thereby urging the distal end of the plunger against the roof, or other surface about the rear view mirror.

Instead of a spring, the means for exerting force may include a twist-to-expand assembly that increasingly applies force between the top of the apparatus, or housing, and the roof, or surface above the rear view mirror, or other object to which the user interface may be mounted. As a user, or installer, twists threaded portions of the twist-to-expand assembly, two portions of the assembly move away, or expand, from each other and increase force on the top of the user interface assembly, or housing thereof, and against the roof surface, or other surface above the rear view mirror. This expansion of the twist-to-expand assembly increases the force of the interface apparatus, or housing thereof, against the mirror, or other object the which it mounts, thus locating, and fixing interface with the mirror. A locking thread pitch on the threaded portions resists untwisting, and thus, relaxation of the force exerted by the securing means.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION

The accompanying drawings, which are incorporated in and constitute a part of this specification, illustrate embodiments and together with the description, serve to explain the principles of the methods and systems:

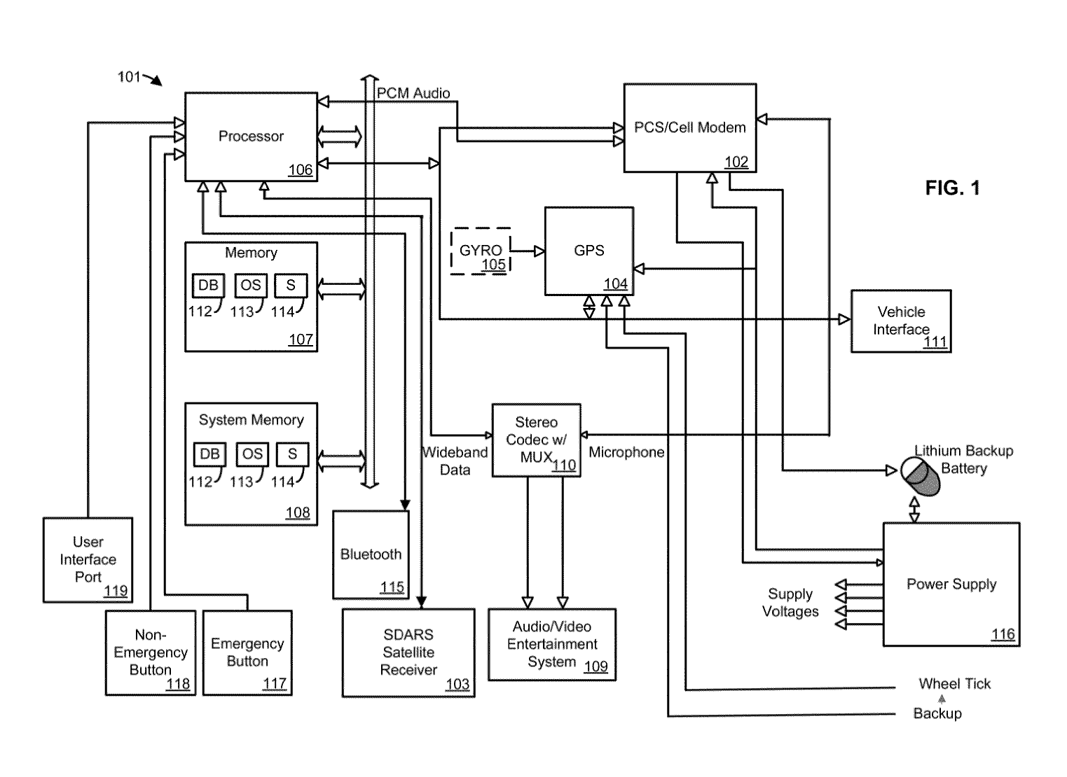

FIG. 1 is an exemplary vehicle telematics unit;

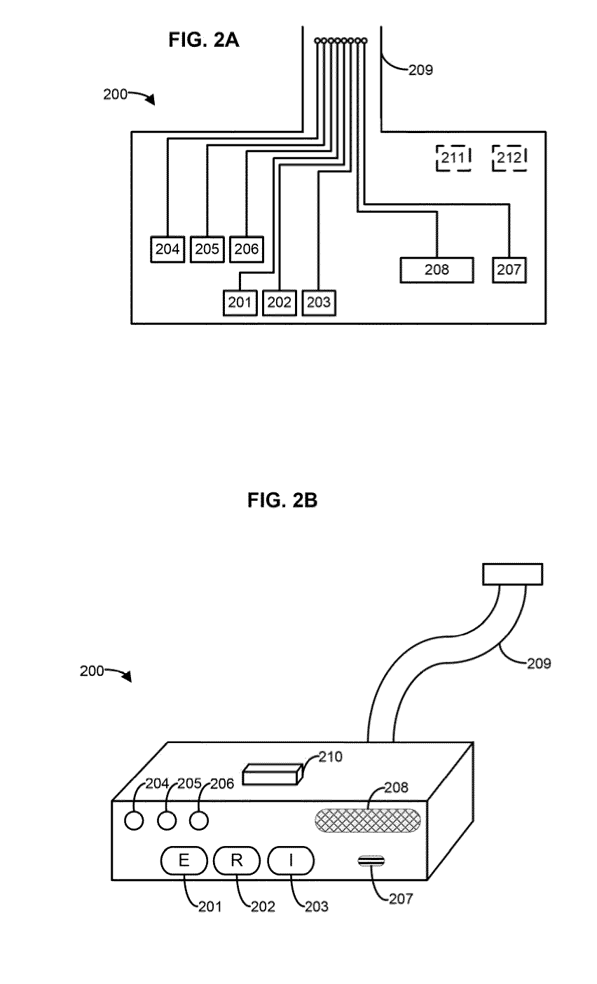

FIG. 2A is an exemplary telematics user interface;

FIG. 2B an exemplary external view of telematics user interface;

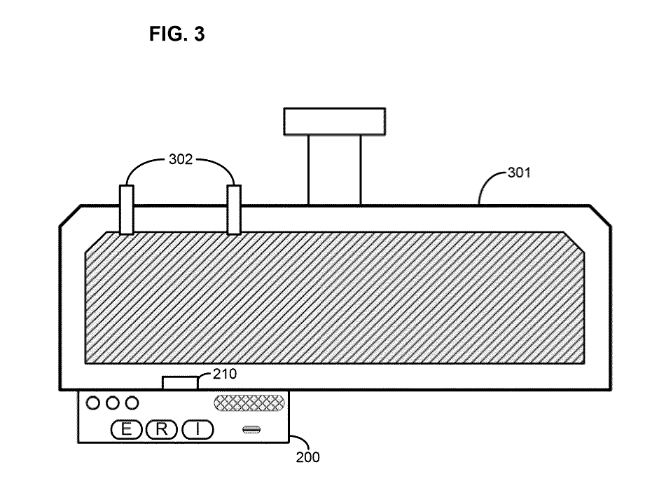

FIG. 3 is a front view of a telematics user interface mounted on a vehicle rearview mirror;

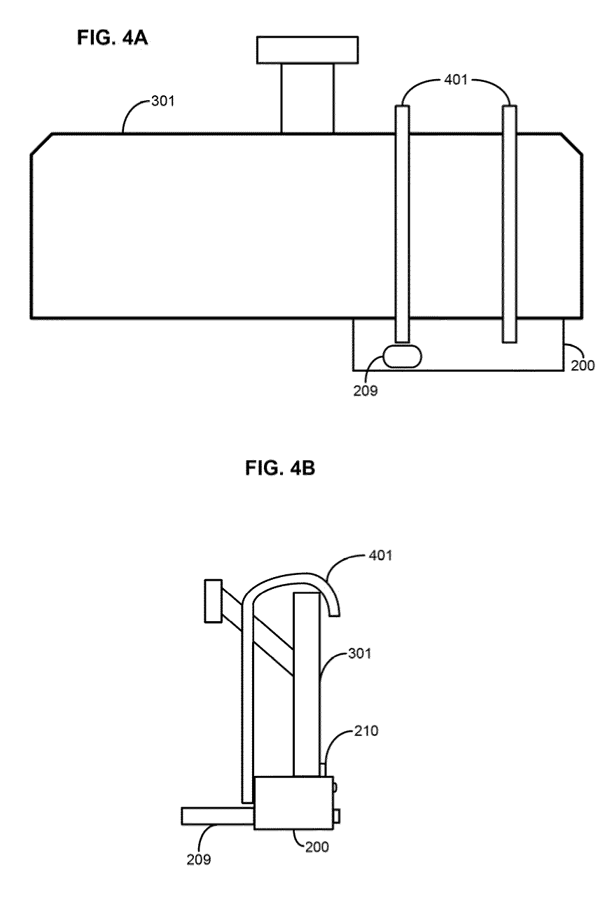

FIG. 4A is a rear view of a vehicle rear view mirror and a telematics user interface;

FIG. 4B illustrates a lateral view of FIG. 4A;

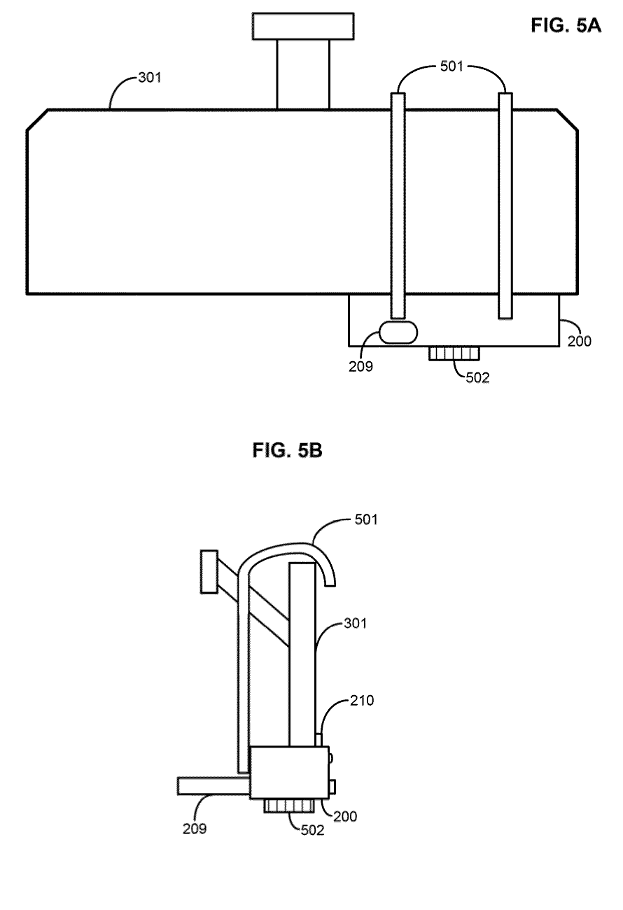

FIG. 5A illustrates a rear view of a vehicle rear view mirror and a telematics user interface utilizing a compression mounting system;

FIG. 5B illustrates a lateral view of rear view mirror;

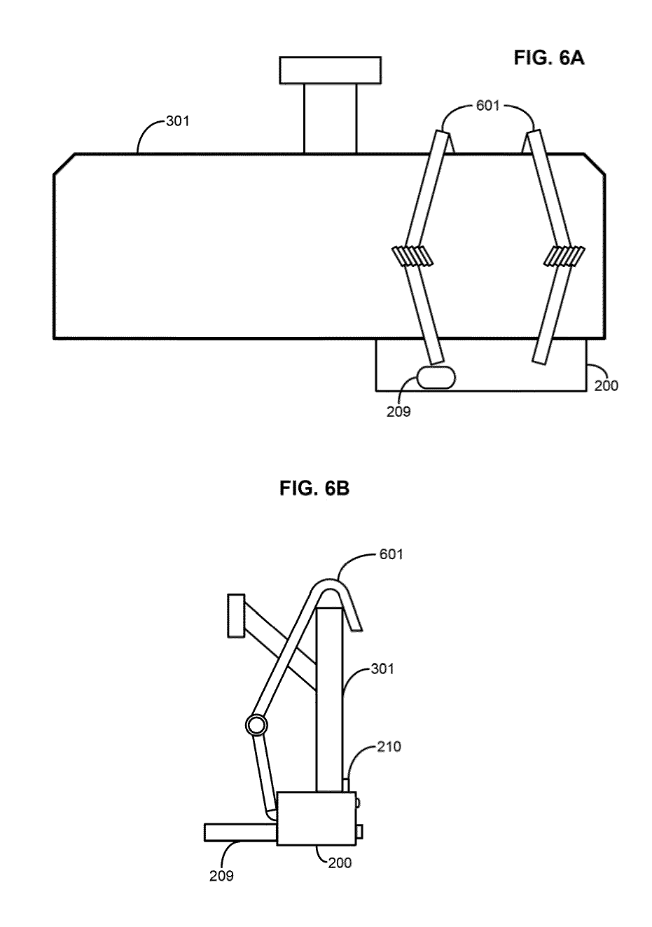

FIG. 6A illustrates a rear view of a vehicle rear view mirror and a telematics user interface utilizing a compression mounting system;

FIG. 6B illustrates a lateral view of rear view mirror;

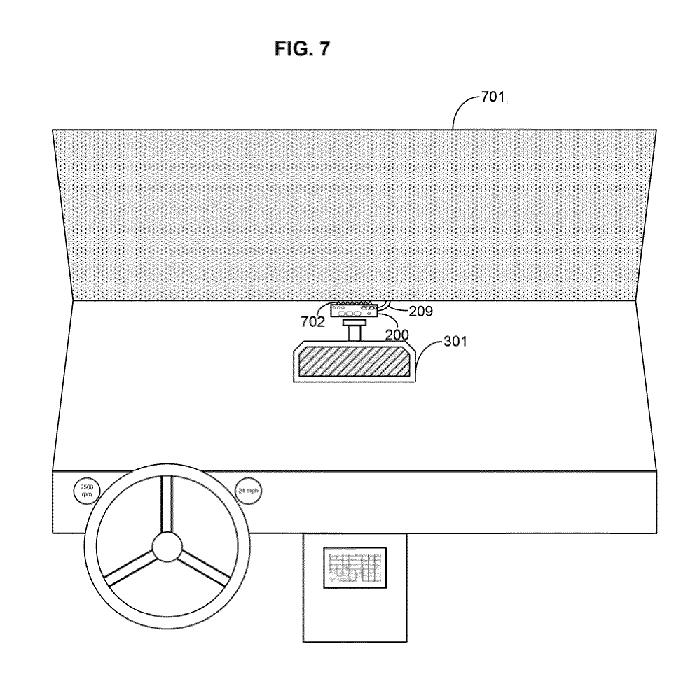

FIG. 7 illustrates an exemplary vehicle cockpit interior;

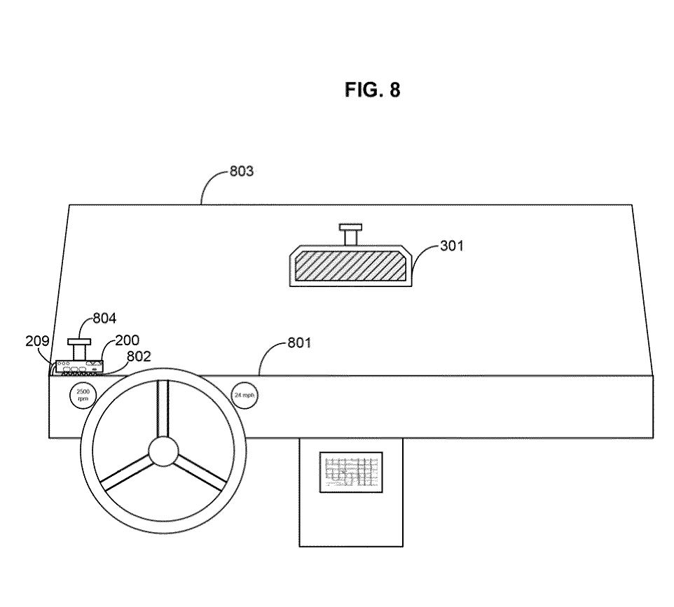

FIG. 8 illustrates an exemplary vehicle cockpit interior; and

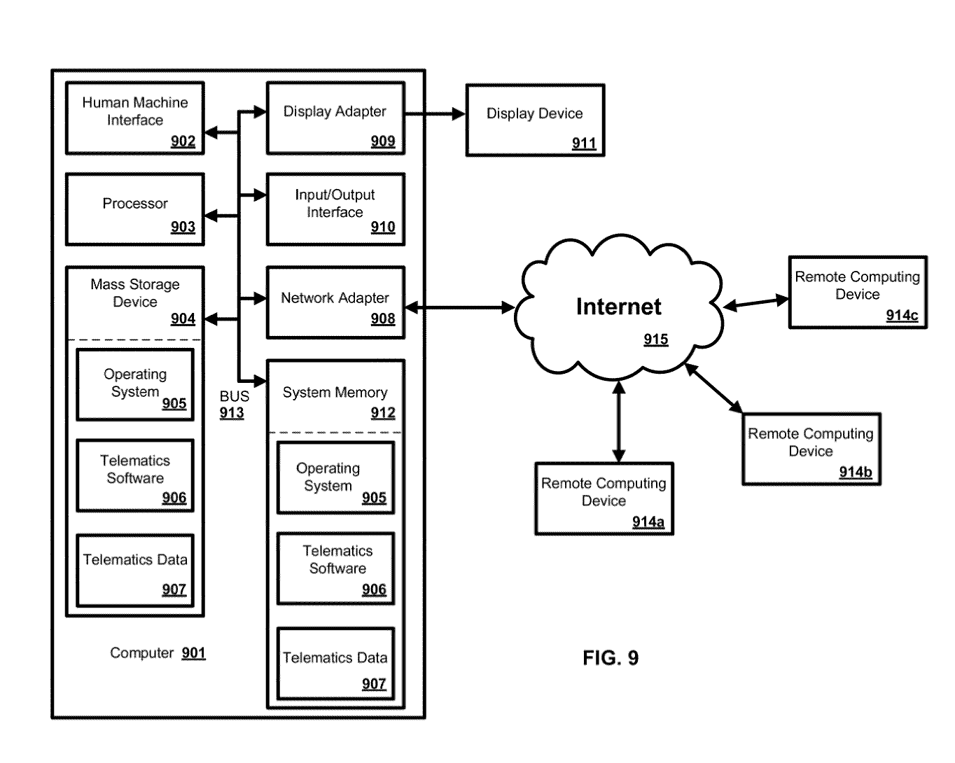

FIG. 9 is a block diagram illustrating an exemplary computer capable of communication with a vehicle telematics unit.

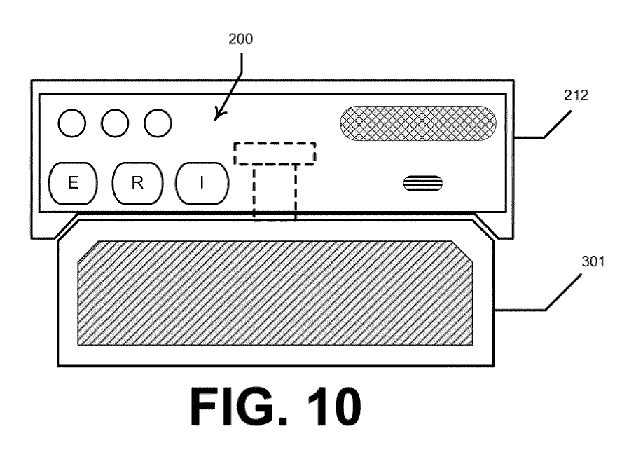

FIG. 10 illustrates a telematics unit interface housed in a housing located atop a rearview mirror.

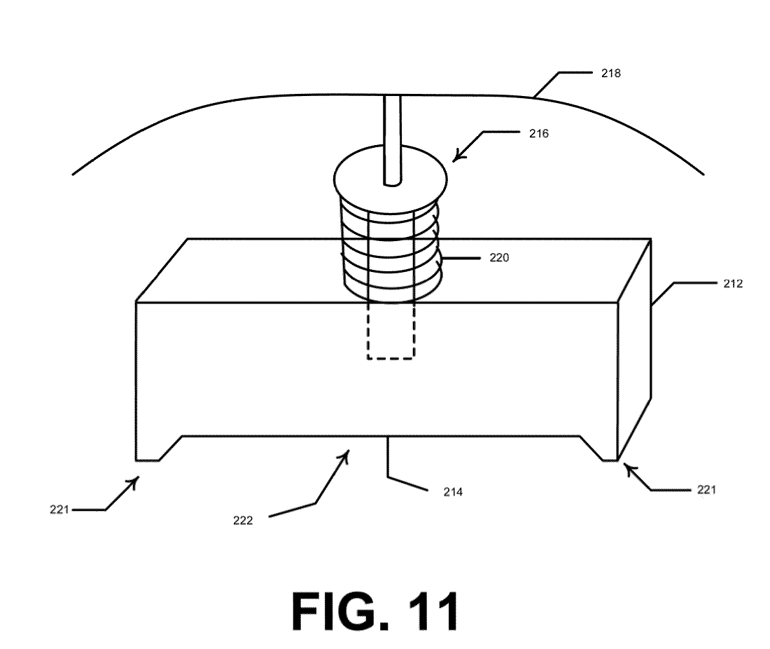

FIG. 11 illustrates a spring loaded locating means that presses against a vehicle roof to force a housing against a rear view mirror.

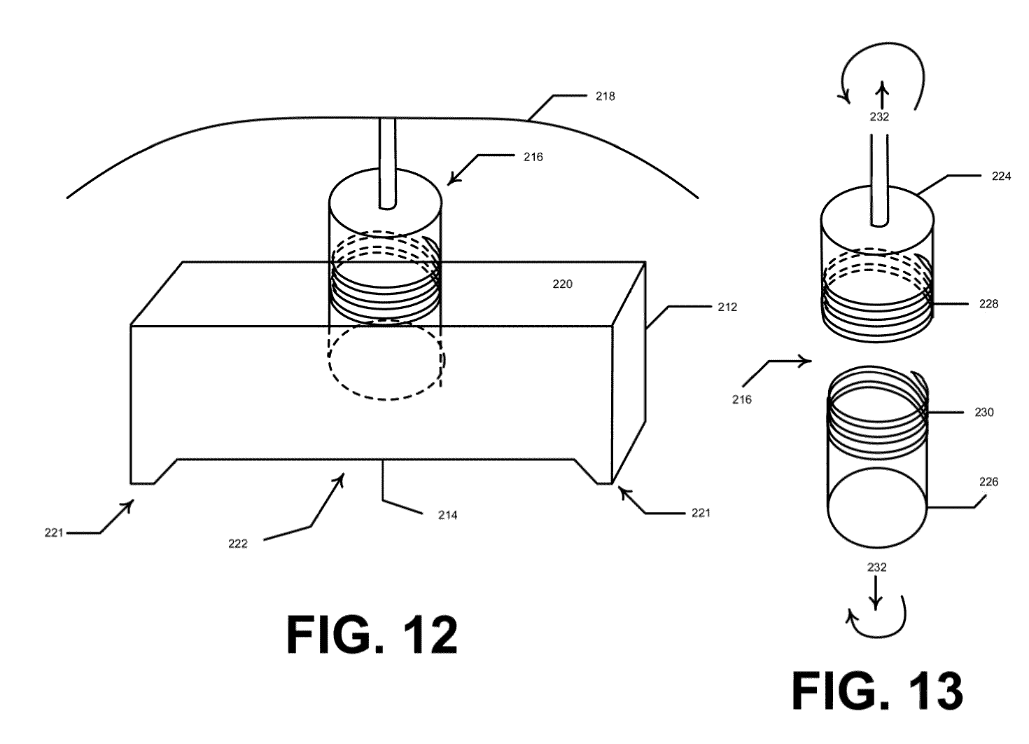

FIG. 12 illustrates a threaded locating means that presses against a vehicle roof to force a housing against a rear view mirror.

FIG. 13 illustrates an exploded view of a threaded locating means.

### DETAILED DESCRIPTION

Before the present methods and systems are disclosed and described, it is to be understood that the methods and systems are not limited to specific synthetic methods, specific components, or to particular compositions, as such may, or course, vary. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

“Mount” can comprise any hardware capable of attaching a vehicle telematics user interface to a vehicle. For example, a mount can be a hook, a spring, and arm, a swivel, a bracket, VELCRO®, and the like.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the Examples included therein and to the Figures and their previous and following description.

In one aspect, provided is an apparatus comprising a telematics unit. The apparatus can be installed in a vehicle. Such vehicles include, but are not limited to, personal and commercial automobiles, motorcycles, transport vehicles, watercraft, aircraft, and the like. For example, an entire fleet of a vehicle manufacturer's vehicles can be equipped with the apparatus. The apparatus 101 is also referred to herein as the VTU 101. The apparatus can perform any of the methods disclosed herein in part and/or in their entireties.

All components of the telematics unit can be contained within a single box and controlled with a single core processing subsystem or can be comprised of components distributed throughout a vehicle. Each of the components of the apparatus can be separate subsystems of the vehicle, for example, a communications component such as a Satellite Digital Audio Radio Service (SDARS), or other satellite receiver, can be coupled with an entertainment system of the vehicle.

An exemplary apparatus 101 is illustrated in FIG. 1. This exemplary apparatus is only an example of an apparatus and is not intended to suggest any limitation as to the scope of use or functionality of operating architecture. Neither should the apparatus be necessarily interpreted as having any dependency or requirement relating to any one or combination of components illustrated in the exemplary apparatus. The apparatus 101 can comprise one or more communications components. Apparatus 101 illustrates communications components (modules) PCS/Cell Modem 102 and SDARS receiver 103. These components can be referred to as vehicle mounted transceivers when located in a vehicle. PCS/Cell Modem 102 can operate on any frequency available in the country of operation, including, but not limited to, the 850/1900 MHz cellular and PCS frequency allocations. The type of communications can include, but is not limited to GPRS, EDGE, UMTS, 1×RTT or EV-DO. The PCS/Cell Modem 102 can be a Wi-Fi or mobile Worldwide Interoperability for Microwave Access (WIMAX) implementation that can support operation on both licensed and unlicensed wireless frequencies. The apparatus 101 can comprise an SDARS receiver 103 or other satellite receiver. SDARS receiver 103 can utilize high powered satellites operating at, for example, 2.35 GHz to broadcast digital content to automobiles and some terrestrial receivers, generally demodulated for audio content, but can contain digital data streams.

PCS/Cell Modem 102 and SDARS receiver 103 can be used to update an onboard database 112 contained within the apparatus 101. Updating can be requested by the apparatus 101, or updating can occur automatically. For example, database updates can be performed using FM subcarrier, cellular data download, other satellite technologies, Wi-Fi and the like. SDARS data downloads can provide the most flexibility and lowest cost by pulling digital data from an existing receiver that exists for entertainment purposes. An SDARS data stream is not a channelized implementation (like AM or FM radio) but a broadband implementation that provides a single data stream that is separated into useful and applicable components.

GPS receiver 104 can receive position information from a constellation of satellites operated by the U.S. Department of Defense. Alternately, the GPS receiver 104 can be a GLONASS receiver operated by the Russian Federation Ministry of Defense, or any other positioning device capable of providing accurate location information (for example, LORAN, inertial navigation, and the like). GPS receiver 104 can contain additional logic, either software, hardware or both to receive the Wide Area Augmentation System (WAAS) signals, operated by the Federal Aviation Administration, to correct dithering errors and provide the most accurate location possible. Overall accuracy of the positioning equipment subsystem containing WAAS is generally in the two meter range. Optionally, the apparatus 101 can comprise a MEMS gyro 105 for measuring angular rates and wheel tick inputs for determining the exact position based on dead-reckoning techniques. This functionality is useful for determining accurate locations in metropolitan urban canyons, heavily tree-lined streets and tunnels.

One or more processors 106 can control the various components of the apparatus 101. Processor 106 can be coupled to removable/non-removable, volatile/non-volatile computer storage media. By way of example, FIG. 1 illustrates memory 107, coupled to the processor 106, which can provide non-volatile storage of computer code, computer readable instructions, data structures, program modules, and other data for the computer 101. For example and not meant to be limiting, memory 107 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

The processing of the disclosed systems and methods can be performed by software components. The disclosed system and method can be described in the general context of computer-executable instructions, such as program modules, being executed by one or more computers or other devices. Generally, program modules comprise computer code, routines, programs, objects, components, data structures. etc. that perform particular tasks or implement particular abstract data types. The disclosed method can also be practiced in grid-based and distributed computing environments where tasks are performed by remote processing devices that are linked through a communications network. In a distributed computing environment, program modules can be located in both local and remote computer storage media including memory storage devices.

The methods and systems can employ Artificial Intelligence techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

Any number of program modules can be stored on the memory 107, including by way of example, an operating system 113 and software 114. Each of the operating system 113 and software 114 (or some combination thereof) can comprise elements of the programming and the software 114. Data can also be stored on the memory 107 in database 112. Database 112 can be any of one or more databases known in the art. Examples of such databases comprise, DB2®, Microsoft® Access, Microsoft® SQL Server, Oracle®, mySQL, PostgreSQL, and the like. The database 112 can be centralized or distributed across multiple systems. The software 114 can comprise telematics software and the data can comprise telematics data.

By way of example, the operating system 113 can be a Linux (Unix-like) operating system. One feature of Linux is that it includes a set of “C” programming language functions referred to as, “NDBM”. NDBM is an API for maintaining key/content pairs in a database which allows for quick access to relatively static information. NDBM functions use a simple hashing function to allow a programmer to store keys and data in data tables and rapidly retrieve them based upon the assigned key. A major consideration for an NDBM database is that it only stores simple data elements (bytes) and requires unique keys to address each entry in the database. NDBM functions provide a solution that is among the fastest and most scalable for small processors.

It is recognized that such programs and components reside at various times in different storage components of the apparatus 101, and are executed by the processor 106 of the apparatus 101. An implementation of reporting software 114 can be stored on or transmitted across some form of computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any method or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

FIG. 1 illustrates system memory 108, coupled to the processor 106, which can comprise computer readable media in the form of volatile memory, such as random access memory (RAM, SDRAM, and the like), and/or non-volatile memory, such as read only memory (ROM). The system memory 108 typically contains data and/or program modules such as operating system 113 and software 114 that are immediately accessible to and/or are presently operated on by the processor 106. The operating system 113 can comprise a specialized task dispatcher, slicing available bandwidth among the necessary tasks at hand, including communications management, position determination and management, entertainment radio management, SDARS data demodulation and assessment, power control, and vehicle communications.

The processor 106 can control additional components within the apparatus 101 to allow for ease of integration into vehicle systems. The processor 106 can control power to the components within the apparatus 101, for example, shutting off GPS receiver 104 and SDARS receiver 103 when the vehicle is inactive, and alternately shutting off the PCS/Cell Modem 102 to conserve the vehicle battery when the vehicle is stationary for long periods of inactivity. The processor 106 can also control an audio/video entertainment subsystem 109 and comprise a stereo codec and multiplexer 110 for providing entertainment audio and video to the vehicle occupants, for providing wireless communications audio (PCS/Cell phone audio), speech recognition from the driver compartment for manipulating the SDARS receiver 103 and PCS/Cell Modem 102 phone dialing, and text to speech and pre-recorded audio for vehicle status annunciation.

The apparatus 101 can interface and monitor various vehicle systems and sensors to determine vehicle conditions. Apparatus 101 can interface with a vehicle through a vehicle interface 111. The vehicle interface 111 can include, but is not limited to, OBD (On Board Diagnostics) port, OBD-II port, CAN (Controller Area Network) port, and the like. The vehicle interface 111, allows the apparatus 101 to receive data indicative of vehicle performance, such as vehicle trouble codes, operating temperatures, operating pressures, speed, fuel air mixtures, oil quality, oil and coolant temperatures, wiper and light usage, mileage, break pad conditions, and any data obtained from any discrete sensor that contributes to the operation of the vehicle engine and drive-train computer. Additionally CAN interfacing can eliminate individual dedicated inputs to determine brake usage, backup status, and it can allow reading of onboard sensors in certain vehicle stability control modules providing gyro outputs, steering wheel position, accelerometer forces and the like for determining driving characteristics. The apparatus 101 can interface directly with a vehicle subsystem or a sensor, such as an accelerometer, gyroscope, airbag deployment computer, and the like. Data obtained, and processed data derived from, from the various vehicle systems and sensors can be transmitted to a central monitoring station via the PCS/Cell Modem 102.

Communication with a vehicle driver can be through an infotainment (radio) head (not shown) or other display device (not shown). More than one display device can be used. Examples of display devices include, but are not limited to, a monitor, an LCD (Liquid Crystal Display), a projector, and the like.

The apparatus 101 can receive power from power supply 116. The power supply can have many unique features necessary for correct operation within the automotive environment. One mode is to supple a small amount of power (typically less than 100 microamps) to at least one master controller that can control all the other power buses inside of the VTU 101. In an exemplary system, a low power low dropout linear regulator supplies this power to PCS/Cellular modem 102. This provides the static power to maintain internal functions so that it can await external user push-button inputs or await CAN activity via vehicle interface 111. Upon receipt of an external stimulus via either a manual push button or CAN activity, the processor contained within the PCS/Cellular modem 102 can control the power supply 116 to activate other functions within the VTU 101, such as GPS 104/GYRO 105, Processor 106/Memory 107 and 108, SDARS receiver 103, audio/video entertainment system 109, audio codec mux 110, and any other peripheral within the VTU 101 that does not require standby power.

In an exemplary system, there can be a plurality of power supply states. One state can be a state of full power and operation, selected when the vehicle is operating. Another state can be a full power relying on battery backup. It can be desirable to turn off the GPS and any other non-communication related subsystem while operating on the back-up batteries. Another state can be when the vehicle has been shut off recently, perhaps within the last 30 days, and the system maintains communications with a two-way wireless network for various auxiliary services like remote door unlocking and location determination messages. After the recent shut down period, it is desirable to conserve the vehicle battery by turning off almost all power except the absolute minimum in order to maintain system time of day clocks and other functions, waiting to be awakened on CAN activity. Additional power slates are contemplated, such as a low power wakeup to check for network messages, but these are nonessential features to the operation of the VTU.

Normal operation can comprise, for example, the PCS/Cellular modem 102 waiting for an emergency push button, key-press, or CAN activity. Once either is detected, the PCS/Cellular modem 102 can awaken and enable the power supply 116 as required. Shutdown can be similar wherein a first level shutdown turns off everything except the PCS/Cellular modem 102, for example. The PCS/Cellular modem 102 can maintain wireless network contact during this state of operation. The VTU 101 can operate normally in the state when the vehicle is turned off. If the vehicle is off for an extended period of time, perhaps over a vacation etc., the PCS/Cellular modem 102 can be dropped to a very low power state where it no longer maintains contact with the wireless network.

Additionally, in FIG. 1, subsystems can include a BlueTooth transceiver 115 that can be provided to interface with devices such as phones, headsets, music players, and telematics user interfaces. The apparatus can comprise one or more user inputs, such as emergency button 117 and non-emergency button 118. Emergency button 117 can be coupled to the processor 106. The emergency button 117 can be located in a vehicle cockpit and activated an occupant of the vehicle. Activation of the emergency button 117 can cause processor 106 to initiate a voice and data connection from the vehicle to a central monitoring station, also referred to as a remote call center. Data such as GPS location and occupant personal information can be transmitted to the call center. The voice connection permits two way voice communication between a vehicle occupant and a call center operator. The call center operator can have local emergency responders dispatched to the vehicle based on the data received. In another embodiment, the connections are made from the vehicle to an emergency responder center.

One or more non-emergency buttons 118 can be coupled to the processor 106. One or more non-emergency buttons 118 can be located in a vehicle cockpit and activated by an occupant of the vehicle. Activation of the one or more non-emergency buttons 118 can cause processor 106 to initiate a voice and data connection from the vehicle to a remote call center. Data such as GPS location and occupant personal information can be transmitted to the call center. The voice connection permits two way voice communications between a vehicle occupant and a call center operator. The call center operator can provide location based services to the vehicle occupant based on the data received and the vehicle occupant's desires. For example, a button can provide a vehicle occupant with a link to roadside assistance services such as towing, spare tire changing, refueling, and the like. In another embodiment, a button can provide a vehicle occupant with concierge-type services, such as local restaurants, their locations, and contact information; local service providers their locations, and contact information; travel related information such as flight and train schedules; and the like.

For any voice communication made through the VTU 101, text-to-speech algorithms can be used so as to convey predetermined messages in addition to or in place of a vehicle occupant speaking. This allows for communication when the vehicle occupant is unable or unwilling to communicate vocally.

In an aspect, apparatus 101 can be coupled to a telematics user interface located remote from the apparatus. For example, the telematics user interface can be located in the cockpit of a vehicle in view of vehicle occupants while the apparatus 101 is located under the dashboard, behind a kick panel, in the engine compartment, in the trunk, or generally out of sight of vehicle occupants.

FIG. 2A and FIG. 2B illustrate an exemplary telematics user interface 200. As shown in FIG. 2A, telematics user interface 200 can functionally comprise one or more user inputs 201, 202, and 203. User inputs 201, 202, and 203 can be, for example, push buttons, touch sensitive areas, and the like. User inputs 201, 202, and 203 can correspond to emergency button 117 and two non-emergency buttons 118. For example, user input 201 can comprise an emergency button 117, user input 201 can comprise a non-emergency button 118 such as a roadside assistance button, and user input 201 can comprise a non-emergency button 118 such as a concierge button. In an aspect, the user inputs 201, 202, and 203 can be illuminated. In another aspect, indicator lights 204, 205, and 206 can be provided to visually communicate with vehicle occupants. For example, indicator light 204 can be red light, indicator light 205 can be a yellow light, and indicator light 206 can be a green light. In an aspect, one or more of the indicator lights can communicate stages of system connectivity to a user. For example, GPS connectivity, voice communication connectivity, and the like. In another aspect, the indicator lights can flash at varying rates. The flash rate can communicate system status and/or system connectivity.

The telematics user interface 200 can also comprise a microphone 207 and a speaker 208. The microphone 207 and speaker 208 can be used by a vehicle occupant to orally communicate with the remote call center. A vehicle occupant can initiate communications with the remote call center by depressing one or more of the user inputs 201, 202, or 203.

Power, ground, and communications signals can be through a wired connection 209 to a user interface port 119 on the apparatus 101. In another aspect, telematics user interface 200 can communicate with the apparatus 101 wirelessly. Telematics user interface 200 can comprise a power source 211 and a wireless transceiver 212. Power source 211 can comprise user replaceable batteries or non-user replaceable batteries. When utilizing non-user replaceable batteries, telematics user interface 200 can comprise a solar charging component (not shown) to restore power to the batteries. Wireless transceiver 212 can comprise, for example, a Bluetooth transceiver. The user inputs 201, 202, and 203, indicator lights 204, 205, and 206, microphone 207 and speaker 208 can be coupled to the power source 211 and wireless transceiver 212 (not shown) to effect communications with the apparatus 101.

FIG. 2B illustrates an exemplary external view of telematics user interface 200. Telematics user interface 200 can comprise an external housing to protect the various components. The external housing can comprise plastic, metal, and like materials. User inputs 201, 202, and 203 can correspond to an emergency input, a roadside assistance input, and a concierge input, respectively. In some aspects, the inputs can be labeled, illuminated, have different tactile coverings, or combinations thereof, to allow a vehicle occupant to distinguish between the various inputs. Indicator lights 204, 205, and 206 can comprise traditional filament bulbs, light emitting diodes, fiber optics, and the like. Indicator lights 204, 205, and 206 can comprise a plurality of colors, including, but not limited to, red, orange, yellow, green, blue, indigo, violet, and combinations thereof. Telematics user interface 200 can comprise an opening in the external housing to allow sound to pass into the housing and into the microphone 207. Similarly, telematics user interface 200 can comprise an opening in the external housing to allow sound to pass out of the housing from speaker 208. Wired connection 209 can contain the necessary wires and cables to enable communications between the telematics user interface 200 and the apparatus 101. Tab 210 can be used to provide support for the telematics user interface when a vehicle occupant places pressure on one or more of the user inputs 201, 202, or 203.

FIG. 3 illustrates a front view of the telematics user interface 200 mounted on a vehicle rearview mirror 301. The telematics user interface can be mounted underneath the vehicle rearview mirror 301 to either side of the rearview mirror 301, centered underneath the rearview mirror 301, or any other position underneath the rearview mirror 301. Hooks 302 allow the telematics user interface 200 to effectively hang from the rearview mirror 301, providing vertical support. Tab 210 provides horizontal support in the event a vehicle occupant places pressure on one or more user inputs.

FIG. 4A is a rear view of rear view mirror 301 and telematics user interface 200 utilizing a hook mounting system. Hooks 401 can be attached to the telematics user interface 200 and hooked over the top of the rearview mirror 301. The hooks 401 can be arranged so as not to interfere with the wired connection 209. FIG. 4B illustrates a lateral view of rear view mirror 301. Hooks 401 provide vertical support for telematics user interface 200, while tab 210 provides horizontal support. As shown, hooks 401 can be arranged so as not to interfere with the wired connection 209.

FIG. 5A illustrates a rear view of rear view mirror 301 and telematics user interface 200 utilizing a compression mounting system. Clips 501 can be attached to the telematics user interface 200 and attached to the top of the rearview mirror 301. The clips 501 can be arranged so as not to interfere with the wired connection 209. Twist knob 502 can be used to draw clips 501 closer to telematics user interface 200, thereby creating a secure attachment to the rear view mirror 301. FIG. 5B illustrates a lateral view of rear view mirror 301. Clips 401 provide vertical support for telematics user interface 200, while tab 210 provides horizontal support. As shown, clips 401 can be arranged so as not to interfere with the wired connection 209.

FIG. 6A illustrates a rear view of rear view mirror 301 and telematics user interface 200 utilizing a compression mounting system. Spring clips 601 can be attached to the telematics user interface 200 and attached to the top of the rearview mirror 301. The spring clips 601 can be arranged so as not to interfere with the wired connection 209. FIG. 6B illustrates a lateral view of rear view mirror 301. Spring clips 601 provide vertical support for telematics user interface 200, while tab 210 provides horizontal support. As shown, spring clips 601 can be arranged so as not to interfere with the wired connection 209.

FIG. 7 illustrates an exemplary vehicle cockpit interior. Telematics user interface 200 can be mounted to the ceiling or headliner 701 of a vehicle. Mount 702 can comprise any means of securely attaching telematics user interface 200 to the ceiling or headliner 701 of a vehicle. Examples include, but are not limited to, screws, bolts, Velcro®, double-sided tape, and the like. Telematics user interface 200 can be mounted anywhere along the ceiling or headliner 701 so long as the telematics user interface 200 is accessible by a vehicle occupant. For purposes of illustration, FIG. 7 illustrates telematics user interface 200 mounted above rear view mirror 301.

FIG. 8 illustrates an exemplary vehicle cockpit interior. In one aspect, telematics user interface 200 can be mounted to the dashboard 801 of a vehicle. Mount 802 can comprise any means of securely attaching telematics user interface 200 to the dashboard 801. Examples include, but are not limited to, screws, bolts, Velcro®, double-sided tape, and the like. Telematics user interface 200 can be mounted anywhere along the dashboard 801 so long as the telematics user interface 200 is accessible by a vehicle occupant. In another aspect, telematics user interface 200 can be mounted to the windshield 803 of a vehicle. Mount 804 can comprise any means of securely attaching telematics user interface 200 to the windshield 803. Examples include, but are not limited to, suction cups, Velcro®, double-sided tape, and the like. Telematics user interface 200 can be mounted anywhere along the windshield 803 so long as the telematics user interface 200 is accessible by a vehicle occupant. For purposes of illustration, FIG. 8 illustrates telematics user interface 200 mounted to the left of the steering wheel.

VTU 101 can communicate with one or more computers, either through direct wireless communication and/or through a network such as the Internet. Such communication can facilitate data transfer, voice communication, and the like. One skilled in the art will appreciate that what follows is a functional description of an exemplary computer and that functions can be performed by software, by hardware, or by any combination of software and hardware.

FIG. 9 is a block diagram illustrating an exemplary computer capable of communication with VTU 101. This exemplary computer is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

Turning now to FIG. 10, the figure illustrates a user interface device 200 contained in a housing 212 formed to mate with a rear view mirror 301. As shown in more detail in FIG. 11, housing 212 includes bottom surface 214 formed to mate with the top of mirror 301 as shown in FIG. 10. To prevent slippage and movement of housing 212 with respect to mirror 301, securing means 216 bears against a surface fixed with respect to the vehicle, such as, for example, the interior portion of the vehicle's roof 218. Biasing means 220 urges securing means 216 against roof surface 218 and urges housing 212 away from surface 218 and against mirror 301. Since bottom surface 214 mates with the top of mirror 301, housing 212 cannot move with respect to the mirror as long as the biasing means 220 exerts force against the top of housing 212. The figure shows a spring representing biasing means 220, but other biasing means could be used, such as an elastic bushing, or a solid block sized to bear against roof 218 and to slightly deform the top of the housing thus using the elasticity of the housing top to provide a biasing force.

When someone has installed apparatus housing 212 on mirror 301, ends 221 (the ‘ends’ terminology refers to the lateral extents of the apparatus housing bottom 214 with respect to the center 222 of the apparatus housing bottom) interact with corresponding ends of mirror 301 shown in FIG. 10 so that movement of the housing with respect to the mirror cannot occur under normal vehicle operating conditions. One skilled in the art will appreciate that although the FIGS. 10 and II illustrate the top of mirror 301 and center portion 222 of bottom 214 as flat, with the ends 221 angled to mate with similarly angled ends of the mirror, a manufacturer could form bottom 214 as curved to mate with a similarly curved top of a mirror, with the ends of bottom 214 being also similarly curved rather than angled. So long as force against the top housing 212 urges the housing against the mirror so that the mating surfaces of the mirror and bottom 214 of housing 212 prevent movement of the housing with respect to the mirror, the apparatus housing remains essentially fixed and secured with respect to the mirror under normal vehicle operating conditions. To enhance the securing of apparatus housing 212 with respect to mirror 301, a user may place a thin, flexible piece of material, such as, for example, a foam or rubber pad, or swatch, between the top of the mirror and the bottom surface 214 of the apparatus housing. The material would enhance friction and reduce movement of the apparatus housing with respect to the mirror, and also reduce noise, such as squeaks and rattles that could occur from housing 212 rubbing on mirror 301. In addition, increasing the friction between the surfaces of the top of mirror 301 and the bottom surface 214 of apparatus 212 reduces the force needs placed on the securing means 216 to secure the apparatus housing with respect to the mirror.

Instead of a spring bearing against a flange of securing means 216, a twist-to-expand device can apply force against the top of housing 212 and vehicle roof surface 218. As shown n FIG. 12, and as shown in more detail in FIG. 13, securing means 216 includes a roof engaging piece 224 and a housing engaging piece 226. Each piece 224 and 226 includes a threaded portion 228 and 230 respectively. When threaded portions 228 and 230 engage with one another and a user twists pieces 224 and 226 in the directions shown in the curved directional arrows shown in FIG. 13, pieces 224 and 226 move away, or expand, from each other as indicated by the straight arrows in the figure. The relationship between the twisting motion and the linear motion of pieces 224 and 226 away from one another occurs when threaded portions 228 and 230 have been formed with left-handed threads. If right-handed threads have been formed into pieces 224 and 226, twisting in directions opposite those shown in the figure will result in motion of pieces 224 and 230 away from one another.

To maintain force against roof 218 and housing 212 after twisting pieces 224 and 226 so that they move away from one another, a manufacturer forms threaded portions 228 and 230 with a thread pitch that effectively locks the position of piece 224 with respect to piece 226. A locking thread pitch can maintain the locked position until a user twists pieces 224 and 226 in directions opposite those shown in FIG. 13, and will not allow the axial force exerted in the direction of directional arrows 232 and 234 to relax until a user twists pieces 224 and 226 in directions opposite those shown in the figure. Thus, securing means 216 maintains force against roof 218 and housing 212 so that the housing cannot move with respect to mirror 301 until a user unlocks the locating means by twisting pieces 224 and 226 in directions opposite those shown in FIG. 13, assuming left-handed threads.

The methods and systems can be operational with numerous other general purpose or special purpose computing system environments or configurations. Examples of well known computing systems, environments, and/or configurations that can be suitable for use with the system and method comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

In another aspect, the methods and systems can be described in the general context of computer instructions, such as program modules, being executed by a computer. Generally, program modules comprise routines, programs, objects, components, data structures, etc. that perform particular tasks or implement particular abstract data types. The methods and systems can also be practiced in distributed computing environments where tasks are performed by remote processing devices that are linked through a communications network. In a distributed computing environment, program modules can be located in both local and remote computer storage media including memory storage devices.

Further, one skilled in the art will appreciate that the system and method disclosed herein can be implemented via a general-purpose computing device in the form of a computer 901. The components of the computer 901 can comprise, but are not limited to, one or more processors or processing units 903, a system memory 912, and a system bus 913 that couples various system components including the processor 903 to the system memory 912.

The system bus 913 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI) bus also known as a Mezzanine bus. The bus 913, and all buses specified in this description can also be implemented over a wired or wireless network connection and each of the subsystems, including the processor 903, a mass storage device 904, an operating system 905, telematics software 906, telematics data 907, a network adapter (or communications interface) 908, system memory 912, an Input/Output Interface 910, a display adapter 909, a display device 911, and a human machine interface 902, can be contained within one or more remote computing devices 914a,b,c at physically separate locations, connected through buses of this form, in effect implementing a fully distributed system. In one aspect, a remote computing device can be a VTU 101.

The computer 901 typically comprises a variety of computer readable media. Exemplary readable media can be any available media that is accessible by the computer 901 and comprises, for example and not meant to be limiting, both volatile and non-volatile media, removable and non-removable media. The system memory 912 comprises computer readable media in the form of volatile memory, such as random access memory (RAM), and/or non-volatile memory, such as read only memory (ROM). The system memory 912 typically contains data such as telematics data 907 and/or program modules such as operating system 905 and telematics software 906 that are immediately accessible to and/or are presently operated on by the processing unit 903. Telematics data 907 can comprise any data generated by, generated for, received from, or sent to the VTU.

In another aspect, the computer 901 can also comprise other removable/non-removable, volatile/non-volatile computer storage media. By way of example, FIG. 9 illustrates a mass storage device 904 which can provide non-volatile storage of computer code, computer readable instructions, data structures, program modules, and other data for the computer 901. For example and not meant to be limiting, a mass storage device 904 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 904, including by way of example, an operating system 905 and telematics software 906. Each of the operating system 905 and telematics software 906 (or some combination thereof) can comprise elements of the programming and the telematics software 906. Telematics data 907 can also be stored on the mass storage device 904. Telematics data 907 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple systems.

In another aspect, the user can enter commands and information into the computer 901 via an input device (not shown). Examples of such input devices comprise, but are not limited to, a keyboard, pointing device (e.g., a “mouse”), a microphone, a joystick, a scanner, tactile input devices such as gloves, and other body coverings, and the like These and other input devices can be connected to the processing unit 903 via a human machine interface 902 that is coupled to the system bus 913, but can be connected by other interface and bus structures, such as a parallel port, game port, an IEEE 1394 Port (also known as a Firewire port), a serial port, or a universal serial bus (USB).

In yet another aspect, a display device 911 can also be connected to the system bus 913 via an interface, such as a display adapter 909. It is contemplated that the computer 901 can have more than one display adapter 909 and the computer 901 can have more than one display device 911. For example, a display device can be a monitor, an LCD (Liquid Crystal Display), or a projector. In addition to the display device 911, other output peripheral devices can comprise components such as speakers (not shown) and a printer (not shown) which can be connected to the computer 901 via Input/Output Interface 910.

The computer 901 can operate in a networked environment using logical connections to one or more remote computing devices 914a,b,c. By way of example, a remote computing device can be a personal computer, portable computer, a server, a router, a network computer, a VTU 101, a PDA, a cellular phone, a “smart” phone, a wireless communications enabled key fob, a peer device or other common network node, and so on. Logical connections between the computer 901 and a remote computing device 914a,b,c can be made via a local area network (LAN) and a general wide area network (WAN). Such network connections can be through a network adapter 908. A network adapter 908 can be implemented in both wired and wireless environments. Such networking environments are conventional and commonplace in offices, enterprise-wide computer networks, intranets, and the Internet 915. In one aspect, the remote computing device 914a,b,c can be one or more VTU 101's.

For purposes of illustration, application programs and other executable program components such as the operating system 905 are illustrated herein as discrete blocks, although it is recognized that such programs and components reside at various limes in different storage components of the computing device 901, and are executed by the data processor(s) of the computer. An implementation of telematics software 906 can be stored on or transmitted across some form of computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any method or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The processing of the disclosed methods and systems can be performed by software components. The disclosed system and method can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. An apparatus comprising:
a telematics user interface; and
a means for securing the telematics user interface to a vehicle rearview mirror.

2. The apparatus of claim 1 wherein the means for securing includes one, or more, clips.

3. The apparatus of claim 1 wherein the means for securing includes a spring loaded plunger assembly.

4. The apparatus of claim 1 wherein the means for securing includes a twist-to-expand assembly.

5. The apparatus of claim 4 wherein the means for twist-to-expand assembly includes separate portions, each defining mating threads having a pitch that resists twisting in a direction opposite a direction that causes the separate portions to move away from one another.

6. An apparatus comprising:
a telematics user interface: and
a mount for attaching the telematics user interface to a vehicle rearview mirror.

7. An apparatus comprising:
a power source;
one or more user inputs;
a microphone and a speaker; and
a user interface port, coupled to the power source, the one or more user inputs, and the microphone and speaker, wherein the user interface port is configured for coupling the apparatus to a vehicle electronics unit.

8. The apparatus of claim 7, wherein the one or more user inputs comprise one or more of, push buttons and touch sensitive areas.

9. The apparatus of claim 7, wherein the one or more user inputs comprise an emergency button.

10. The apparatus of claim 7, wherein the one or more user inputs comprise a non-emergency button.

11. The apparatus of claim 7, wherein the one or more user inputs are illuminated.

12. The apparatus of claim 7, wherein the power source comprises a user replaceable battery.

13. The apparatus of claim 7 further comprising a housing, the housing defining a bottom surface having outer ends formed lower than a center of the bottom surface to mate with the top of an existing rearview mirror; the housing also defining a top; and a means for securing the apparatus with respect to the rear view mirror that exerts force against the roof of a vehicle in which the rear view mirror and apparatus are mounted.

14. The apparatus of claim 13 wherein the means for securing the apparatus includes a plunger assembly that includes a plunger defining a flange and a distal end, and a spring that exerts force against the top and against the flange thereby urging the distal end against the roof of the vehicle in which the rear view mirror and apparatus are mounted.

15. The apparatus of claim 13 wherein the means for exerting force includes a twist-to-expand assembly that increasingly applies force between the top of the housing and the roof of the vehicle in which the rear view mirror and apparatus are mounted as an operator causes twisting of threaded portions of the twist-to-expand assembly.

16. The apparatus of claim 7, further comprising a wireless transceiver.

17. The apparatus of claim 7, further comprising a mount for attaching the apparatus to a vehicle review mirror.

18. The apparatus of claim 17, wherein the mount comprises a compression mount.

19. The apparatus of claim 17, wherein the mount comprises one, or more, clips have a shape substantially similar to the form of the back of the rearview mirror.
